(19) United States
(12) Patent Application Publication
(10) Pub. No.: US 2006/0153276 A1
(43) Pub. Date: Jul. 13, 2006

(54) Temperature measuring system and method

(76) Inventors: Jens Hartmann, Eschenburg-Wissenbach (DE); Ullrich Hetzler, Dillenburg-Oberscheid (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/295,966

(22) Filed: Dec. 7, 2005

(30) Foreign Application Priority Data
Dec. 7, 2004 (DE) 10 2004 058 931.3

(51) Int. Cl. G01K 7/00

(52) U.S. Cl. 374/172; 374/179

(57) ABSTRACT

The invention relates to a temperature measuring system (1) with a temperature sensor (2), which generates a temperature measurement signal in dependence of a temperature to be measured in accordance with a sensor-specific measurement characteristic curve, and a corrective element (4), which is arranged downstream from the temperature sensor (2) and, from the temperature measurement signal according to a correction characteristic curve, determines a corrected temperature measurement signal that lies in a tolerance range of a specified standard characteristic curve.

### BACKGROUND OF THE INVENTION

The invention relates to a temperature measuring system and an appurtenant temperature measuring method.

It is known to use thermocouples for temperature measurement where these thermocouples generate a thermo-electric voltage depending on the temperature to be measured. This is based on the so-called Seebeck effect. Such thermocouples consist of two conductors with different chemical composition, which are connected so as to form an electric circuit. If the two connecting points of the two conductors lie on different temperature levels, a thermoelectric voltage occurs, which is a direct measure for the temperature difference between the two connecting points. Such thermocouples for the temperature measurement are, for example, standardized in the technical standard IEC 60584, this standard stating the temperature dependence of the thermoelectric voltage in the form of a characteristic curve and defining an allowable tolerance range of ±2.5 K or ±0.75%. The standard IEC 60584, however, is merely an example of many technical standards in this field.

A disadvantage with the known thermocouples for temperature measurement, as described above, is the fact that a considerable fabrication effort is required so that the temperature dependence of the thermo-electric voltage corresponds as exactly as possible to the specified technical standards.

A temperature measuring system is furthermore known from US2004/0102914A1 where a time-related change (“drift”) of the measuring reaction is compensated for the purpose of achieving a measurement as precise as possible. However, an adaptation of the measuring reaction to a specified standard characteristic curve is not known from this printed publication.

Furthermore, a conventional linearization circuit is known from DE 30 30 990 A1, which can be deployed for the linearization of the output signal of a thermocouple. However, this linearization circuit allows only a linearization of the measuring reaction. An adaptation to a specified standard non-linear characteristic curve is, however, not possible in this case.

Furthermore, a temperature measuring method is known from DE 44 12 973 C2 that is used for measuring the supply temperature and the return flow temperature in a warm water supply system of a building. In this case, the temperature is measured by means of temperature sensors corresponding to a sensor-specific measurement characteristic curve, a characteristic curve correction being performed in order to increase the measurement accuracy. An adaptation to a specified standard characteristic curve is not envisaged in this case, however, but rather an improvement of the measurement accuracy.

From DE 37 51 708 T2, an electronic thermometer is furthermore known that calculates in advance the stationary final value for a temperature measurement, which enables a faster measurement.

The invention is therefore based on the problem of reducing the fabrication effort with a temperature measuring system with a thermocouple as required for adherence to the specified technical standards. In addition, the invention is based on the problem of increasing the measuring accuracy, which is realizable with a specified fabrication work effort. Furthermore, the invention is based on the problem of stating and presenting a corresponding temperature measuring method.

This problem is solved by a temperature measuring system and/or a temperature measuring method according to the invention.

### SUMMARY OF THE INVENTION

The invention comprises the general technical of achieving adherence to the technical standards not by means of a most precise and thus costly fabrication of the thermocouple with a defined temperature dependence of the generated thermo-electric voltage, but rather by means of a corrective element arranged downstream that corrects the thermoelectric voltage generated by the thermocouple according to a sensor-specific correction characteristic curve in such a way that the specified technical standards with reference to the freely selectable standardized thermocouple types can be adhered to and/or remaining deviations are further reduced.

This enables in an advantageous manner a cost-effective fabrication of the thermocouple as an analogous signal transmitter, consisting of practically all random materials, which only have to fulfill the metallurgical and mechanical requirements such as thermoelectric time stability, homogeneity and oxidation resistance but, however, do not have to comply with thermoelectric standards because the sensor scattering of the temperature dependence is equalized sensor-specifically by the corrective element arranged downstream in accordance with the correction characteristic curve.

The invention, however, not only aims at the reduction of the manufacturing costs where, because of the characteristic curve correction, cost-effective materials can be used. In fact, the invention also makes an improvement of the measurement accuracy possible where the use of high quality materials is involved. Preferably, the corrected temperature measurement signal therefore has a relatively small scattering that is substantially smaller than the allowable tolerance range of the standard characteristic curve so that the specified standard is exceeded by far with regard to its accuracy requirements. For example, the scattering of the corrected temperature signal with the temperature measuring system according to the invention can be smaller than 75%, 50%, 25%, 10% or even smaller than 5% of the tolerance range of the standard characteristic curve. Therefore, the invention is not limited to the use of non-standardized thermal materials. In fact, standardized thermal materials can also be used within the framework of the invention, wherein the invention then makes possible an improvement of the measurement accuracy over the standard requirements.

In this case, the temperature measuring system according to the invention forms preferably an inseparable unit with the temperature sensor and the corrective element arranged downstream.

Since a temperature measurement with a thermocouple is always a relative temperature measurement, the one side of the thermocouple must be brought to a so-called reference temperature in a conventional manner. This reference temperature is normally measured with an additional temperature sensor. Where the invention is concerned, this additional measurement can be omitted if the deployed ASIC contains an internal temperature measurement, which can then be used as a reference point temperature.

The temperature measuring system according to the invention has preferably a thermocouple as a temperature sensor, as already mentioned above and is known as such. In the same manner, however, the invention can also be realized with other types of temperature sensors such as, for example, temperature-dependent resistors (e.g. PTCs, NTCs). The invention is thus not limited to temperature measuring systems where a thermocouple is used as a temperature sensor, but also comprises temperature measuring systems where a temperature-dependent resistor is used as a temperature sensor.

Between the temperature sensor and the corrective element, an analog-digital converter is preferably arranged, which converts the thermoelectric voltage being present in analog form and, as necessary, the measurement signal of the reference temperature into a corresponding digital signal, which is then processed in the digitally functioning corrective element. The digital processing of the temperature measurement signal in the corrective element enables a simple correction corresponding to the specified correction characteristic curve.

In a variant of the invention with a digital corrective element, a digital-analog converter is arranged downstream to the corrective element, which converter converts the digitized and corrected temperature measurement signal into an analog signal again, which signal is then available in a conventional manner as a measurement signal. For example, the analog signal generated by the digital-analog converter can be an electric signal in the range of 0-20 mA or 4-20 mA or a voltage signal in the range of 0-5 V or 0-10 V.

In another variant of the invention with a digital corrective element, a bus driver, by contrast, is arranged downstream to the corrective element and this driver is connectable to a digital data bus (e.g., USB, RS242, RS485, CAN, LIN, Profi-bus, DIN-bus, Ethernet), and enables a digital measurement signal processing of the output temperature or the corrected thermoelectric voltage.

Preferably, the correction characteristic curve in the corrective element is adjustable in order to make possible an adaptation to the sensor-specific measurement characteristic curve of the individual temperature sensor. Preferably and for this purpose, the actual measurement characteristic curve of the temperature sensor is measured in the factory and from this the correction characteristic curve can be calculated as necessary for the correction, so that the corrected temperature measurement signal lies in a specified tolerance range of the standard characteristic curve. The setting of the correction curve is performed preferably on the manufacturer's side within the framework of a preceding calibration before the actual measuring operation.

However, it is also possible that the correction characteristic curve is adapted to an ageing-related change of the sensor-specific measurement characteristic curve after delivery during the measuring operation. It should be noted that thermocouples are subject to ageing because of oxidation, diffusion, contamination/fouling and changes in the lattice structure. Such ageing appearances also have an effect on the actual measurement characteristic curve, and that can be compensated in the on-going measuring operation by means of a corresponding adaptation of the correction characteristic curve. In addition, the correction characteristic curve can also be changed independently of sensor-specific or ageing-related deviations in order to obtain an adaptation to another standard characteristic curve.

Furthermore, it is to be mentioned that the correction characteristic curve is preferably set individually for each single temperature sensor and not for a plurality of temperature sensors of any certain sensor type. In this way, individual structural component scattering can be taken into consideration during the correction.

A particularly advantageous aspect of the invention is the option of using cost-effective materials for the conductor of the thermocouple such as, for example, nickel or heat-resistant steel.

Moreover, the invention enables a cost-effective manufacturing method for the thermocouple where the structural component scattering of the measurement characteristic curve of the temperature sensor can be larger than the tolerance of the specified standard characteristic curve.

It is to be mentioned furthermore that the temperature sensor, the analog-digital converter, the corrective element, the digital-analog converter and/or the bus driver are preferably arranged in a common housing and/or form an inseparable unit.

### BRIEF DESCRIPTION OF THE DRAWINGS

Other advantageous further developments of the invention are explained as follows in greater detail together with the description of the preferred embodiment examples of the invention as based on the Figures. These Figures show the following:

FIG. 1: a simplified block diagram of a temperature measuring system according to the invention and

FIG. 2: a block diagram of an alternative embodiment example of a temperature measuring system according to the invention.

### DETAILED DESCRIPTION OF PREFERRED EMBODIMENTS

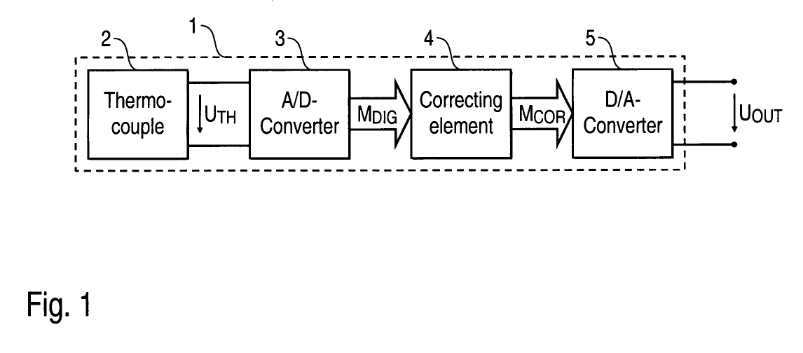

The block diagram in FIG. 1 shows a temperature measuring system 1 according to the invention, which has a thermocouple 2 as a temperature sensor and which has two electric conductors consisting of different types of materials that are connected at two connecting points so as to form an electric circuit. Here, one of the two connecting points is measured with a further temperature sensor whereas the other connecting point is subjected to the temperature to be measured so that the thermocouple 2, based on the known Seebeck effect, produces a thermoelectric voltage U_{TH}, which is a direct measure for the temperature difference and, subsequently, for the temperature to be measured.

The thermoelectric voltage U_{TH} existing in analog form is then led to an analog-digital converter 3, which produces a digitized voltage signal M_{DIG} that reproduces the thermoelectric voltage U_{TH} and, subsequently, also the temperature difference to be measured in digital form.

The digitized voltage signal M_{DIG} is then led to a corrective element 4, which produces a corrected voltage signal M_{COR} from the digitized voltage signal M_{DIG} and the parallely measured reference point temperature according to a specified correction characteristic curve, reproducing the measured temperature according to the selected thermocouple type and according to the selected technical standard (e.g., IEC 60584).

Finally, the corrected voltage signal M_{COR} is led to a digital-analog converter 5, which produces a conventional analog voltage signal U_{OUT} that can be evaluated in the usual manner as for the conventional thermocouples. There is the alternative option that the digital-analog converter 5 produces an analog current signal that represents the measured temperature difference.

The corrective element 4 functions in a digital way in this case and corrects the digitized voltage signal M_{DIG} according to a specified correction characteristic curve, which was determined beforehand in a previous calibration operation. For this purpose, the actual measurement characteristic curve of the thermocouple 2 is measured at first, where the measurement characteristic curve can have considerable sensor-specific scattering without having any detrimental effects on the accuracy of the temperature measurement. From the actual measurement characteristic curve determined in this way, the correction characteristic curve is determined in such a way that a link of the actual measurement characteristic curve with the correction characteristic curve leads to the selected standard characteristic curve according to the selected technical standard (e.g., IEC 60584). Based on the correction by the corrective element 4, the thermocouple 2 only has to adhere to very rough tolerances and/or can display a completely different thermoelectric reaction, a fact which enables cost-effective manufacturing.

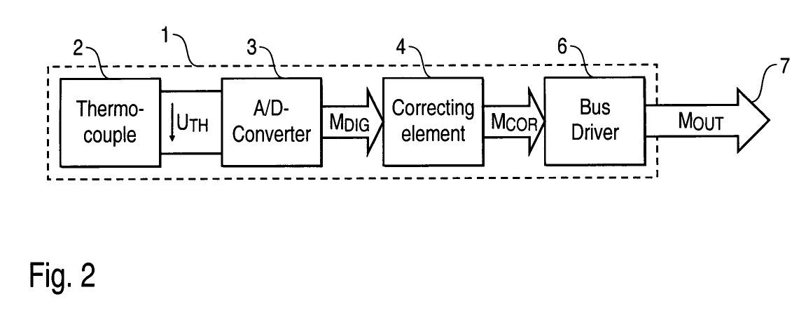

The alternative embodiment example shown in FIG. 2 coincides extensively with the embodiment example as just described and shown in FIG. 1, so that reference is made here to the description given above for FIG. 1 in order to avoid repetitions, the same reference signs being adopted for the corresponding structural components.

A special feature of this embodiment example lies in the fact that no digital-analog converter 5 is arranged downstream to the corrective element 4, but instead a bus driver 6 is arranged downstream that can be connected to a data bus 7 shown here schematically only, and enables a digital further processing of the temperature measurement signal M_{OUT}. The signal discharged on the output side can also be—as already mentioned above—a current or a voltage signal that reproduces the measured temperature difference.

The invention is not restricted to the two preferred embodiment examples as described above. In fact, a plurality of variants and modifications is possible, which also make use of the thought and concept of the invention and, for this reason, lie within the scope of protection.

What is claimed is:

1. A temperature measuring system, comprising:
a temperature sensor that generates a temperature measurement signal in dependence of a temperature to be measured according to a sensor-specific measurement characteristic curve; and
a corrective element which is arranged downstream from the temperature sensor and, from the temperature measurement signal in accordance with a correction characteristic curve, determines a corrected temperature signal that lies in a tolerance range of a specified standard characteristic curve.

2. The temperature measuring system according to claim 1, wherein the temperature sensor is a thermocouple that generates a temperature-dependent thermoelectric voltage.

3. The temperature measuring system according to claim 1, wherein an analog-digital converter is between the temperature sensor and the corrective element, the corrective element functioning in a digital manner.

4. The temperature measuring system according to claim 3, wherein a digital-analog converter is arranged downstream from the digital corrective element.

5. The temperature measuring system according to claim 3, wherein a bus driver is arranged downstream from the digital corrective element and is connectable to a digital data bus.

6. The temperature measuring system according to claim 1, wherein the correction characteristic curve is adjustable.

7. The temperature measuring system according to claim 1, wherein the temperature sensor, the analog-digital converter, the corrective element and the digital-analog converter are arranged in a common housing and form an inseparable unit.

8. The temperature measuring system according to claim 1, wherein the temperature sensor, the analog-digital converter, the corrective element and the bus driver are arranged in a common housing and form an inseparable unit.

9. The temperature measuring system according claim 1, wherein a structural component scattering of the measurement characteristic curve of the temperature sensor is larger than the tolerance range of the specified standard characteristic curve.

10. The temperature measuring system according to claim 1, wherein the thermocouple has conductors comprising non-standardized thermal materials.

11. A temperature measuring method comprising the following steps:
generation of a temperature measurement signal in dependence of a temperature to be measured according to a sensor-specific measurement characteristic curve; and
correction of the temperature measurement signal according to a specified correction characteristic curve so that the corrected temperature measurement signal lies in an allowable tolerance range of a specified standard characteristic curve.

12. The temperature measuring method according to claim 11, wherein the temperature measurement signal is measured by a thermocouple.

13. The temperature measuring method according to claim 11, wherein the temperature measurement signal is digitized before the correction and then digitally corrected.

14. The temperature measuring method according to claim 13, wherein the corrected and digitized temperature measurement signal is converted after the correction into an analog signal.

15. The temperature measuring method according to claim 13, wherein the corrected and digitized temperature measurement signal is led to a data bus.

16. The temperature measuring method according to claim 11, wherein the correction characteristic curve is set in a factory before an actual measuring operation.

17. The temperature measuring method according to claim 11, wherein the correction characteristic curve, during a measuring operation or during interruptions of the measuring operation, is adapted to an ageing-related change of the sensor-specific measurement characteristic curve.

18. The temperature measuring method according to claim 11, wherein the correction characteristic curve is changed for adaptation to another standard characteristic curve.

19. The temperature measuring method according to claim 11, wherein the correction characteristic curve can also be subsequently adapted to each and any random standard characteristic curve for adaptation to requirements of a user.

20. The temperature measuring method according to claim 11, wherein structural component scattering of the measurement characteristic curve is larger than the tolerance range of the specified standard characteristic curve.

21. The temperature measuring method according to claim 11, wherein additionally a reference point temperature is measured and is taken into consideration during the generation of the temperature measurement signal.
